(19) United States
(12) Patent Application Publication
(10) Pub. No.: US 2015/0206468 A1
(43) Pub. Date: Jul. 23, 2015

(54) WHITE BALANCE DEVICE FOR VIDEO SCREEN

(71) Applicant: FU-CHI WU, NORTHRIDGE, CA (US)

(72) Inventor: FU-CHI WU, NORTHRIDGE, CA (US)

(21) Appl. No.: 14/159,571

(22) Filed: Jan. 21, 2014

(51) Int. Cl. G09G 3/20

(52) U.S. Cl. CPC G09G 3/2003; G09G 3/2007; G09G 2320/0666; G09G 2320/08

(57) ABSTRACT

A white balance device includes a white or gray light transmitting sheet and a color temperature sensing element for use in an electronic apparatus. The white or gray light transmitting sheet converts incident light into a neutral light, causing the color temperature sensing element to induce a spot color temperature signal, enabling the CPU of the electronic apparatus to obtain an accurate white balance (color temperature) value through a white balance calculation process and to further adjust the color temperature of the display device of the electronic apparatus.

### BACKGROUND OF THE INVENTION

1. Field of the Invention

The present invention relates to image pick-up technology, and more particularly, to a white balance device comprised of a white or gray light transmitting sheet and a color temperature sensing element and installed in a television, computer monitor, computer main unit, notebook computer, tablet computer, camera, video camera, video recorder, video monitor, network camera, video projector or mobile phone, for inducing a spot color temperature signal and to provide the signal to a CPU of the television, computer monitor, computer main unit, notebook computer, tablet computer, camera, video camera, video recorder, video monitor, network camera, video projector or mobile phone so that the CPU can obtain an accurate white balance (color temperature) value and automatically adjust the color temperature of the video screen being displayed to become close to the natural color of the shooting scene.

2. Description of the Related Art

A video screen is capable of receiving a color temperature value, and then automatically adjusting its color temperature value, or enabling its color temperature value to be adjusted manually to meet the color temperature of the ambient light. Human eyes are capable of automatically adjust the color temperature. If a video screen cannot automatically adjust its color temperature value, human eyes will be unable to view the displayed videos in the correct color, causing the eyes to produce visual changes and to feel the color display to be unnatural. It is desirable to have a video screen capable of automatically adjusting its color temperature, or displaying the spot white balance color temperature value on the display window for manual adjustment. Ordinary people lack in this knowledge and may misunderstand that an electrical video appliance has a poor quality if the color setting of the electrical video appliance is incorrect.

A video screen performs the display function based on a fixed color temperature, for example, 6500K is set as the default value. However, the ambient color temperature value in the work place around a video screen varies with time and the located environment. When the color temperature value of the light source in the work place falls upon the video screen, it will affect the color temperature value of the video screen, or raise or drop the surface color temperature value of the display screen, causing a change in the eye pressure of the color-sensitive human eyes, and resulting in feeling of incorrect color display. To an ordinary person, it is very difficult to adjust the color of a video screen. Further, indoor color temperature may be changed frequently due to mixing of different indoor and outdoor light sources, complicating the adjustments of the color temperature of a video screen, and making the adjustment almost infeasible. When watching a video screen in the dark, such as in a movie theater, the video screen is free from the interference of ambient light, and people can see the exhibition of correct color.

At the present time, regular video screens, including the display screens of commercial cameras and video cameras, do not provide an automatic white balance design. The color temperature of outdoor sunlight changes with the progress of time during the day. In a test of an advanced color temperature adjustable camera with the color temperature adjustment unit of 100K, the display screen of the camera was pre-set, enabling the display screen of the camera to approximately meet the color of indoor objects after manual white balance adjustment, and then the color temperature was adjusted to manual adjustment function. However, in the test, manual adjustment cannot get the correct color temperature. This test shows the truth that it is very difficult or even not possible to an ordinary person to accurately adjust the color temperature of a video screen, not to mention the effect of continuous change in ambient color temperature on color change and eye vision.

### SUMMARY OF THE INVENTION

The present invention has been accomplished under the circumstances in view. The invention has a video screen such as television, computer monitor, tablet computer, camera, video camera, video projector or mobile phone be equipped with a white balance device that comprises a white or gray light transmitting sheet and a color temperature sensing element. When external light passes through the white or gray light transmitting sheet, the white or gray light transmitting sheet converts incident light into a neutral light, causing the color temperature sensing element to induce a spot color temperature signal and to provide the signal to the CPU of the television, computer monitor, tablet computer, camera, video camera, video projector or mobile phone for white balance calculation. Thus, the CPU can obtain the accurate white balance value and adjust the spot color temperature of the video screen.

It is therefore the main object of the present invention to provide a white balance device, which comprises a white or gray light transmitting sheet and a color temperature sensing element and is installed in a television, computer monitor, computer main unit, notebook computer, tablet computer, camera, video camera, video recorder, video monitor, network camera, video projector or mobile phone. The white or gray light transmitting sheet converts incident light into a neutral light, causing the color temperature sensing element to induce a spot color temperature signal and to provide the signal to a CPU of the television, computer monitor, computer main unit, notebook computer, tablet computer, camera, video camera, video recorder, video monitor, network camera, video projector or mobile phone where the CPU runs a white balance calculation processing on the retrieved color temperature value to obtain an accurate white balance (color temperature) value and to further adjust the spot color temperature of the video screen, enabling human eyes to see the displayed pictures or videos in the correct color that is close to the natural color of the shooting scene.

It is another object of the present invention to provide a white balance device, which comprises a white or gray light transmitting sheet and a color temperature sensing element.

When external light passes through the white or gray light transmitting sheet, the white or gray light transmitting sheet converts incident light into a neutral light, causing the color temperature sensing element to induce a spot color temperature signal and to provide the signal to the CPU of the television, computer monitor, tablet computer, camera, video camera, video projector or mobile phone for white balance calculation to obtain an accurate white balance (color temperature) value, enabling the accurate white balance (color temperature) value to be displayed on a window of the display screen of said television, computer monitor, computer main unit, notebook computer, tablet computer, camera, video camera, video recorder, video monitor, network camera, video projector or mobile phone for enabling the spot color temperature value to be displayed on the windows of the display screen for manual adjustments.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic drawing illustrating a white balance device installed in a television in accordance with the present invention.

FIG. 2 is a schematic sectional side view of the embodiment shown in FIG. 1.

FIG. 2-1 illustrates a white balance device installed in a remote controller, a mini network computer or a TV stick in accordance with the present invention.

FIG. 3 is a schematic drawing illustrating a white balance device installed in a computer monitor in accordance with the present invention.

FIG. 4 is a schematic sectional side view of the embodiment shown in FIG. 3.

FIG. 5 is a schematic drawing illustrating a white balance device installed in a computer main unit in accordance with the present invention.

FIG. 6 is a schematic sectional side view of the embodiment shown in FIG. 5.

FIG. 6-1 is a schematic drawing illustrating a white balance device respectively installed in a keyboard and a computer mouse of a computer system in accordance with the present invention.

FIG. 7 illustrates a detachable white balance device detachably connectable to a computer main unit in accordance with the present invention.

FIG. 8 is a schematic drawing illustrating a white balance device installed in a notebook computer in accordance with the present invention.

FIG. 9 is a schematic sectional side view of the embodiment shown in FIG. 8.

FIG. 9-1 is a schematic drawing illustrating a white balance device installed in a tablet computer in accordance with the present invention.

FIG. 10 is a schematic drawing illustrating a white balance device installed in a front side of a mobile phone in accordance with the present invention.

FIG. 11 is a schematic drawing illustrating a white balance device installed in a back side of a mobile phone in accordance with the present invention.

FIG. 12 illustrates a television, a computer monitor, a computer main unit and a notebook computer respectively equipped with a wireless receiver for receiving a white balance value from a mobile phone in accordance with the present invention.

FIG. 13 illustrates an independent white balance device equipped with a wireless transceiver and a battery for the transmission of obtained white balance value to a television, a computer monitor, a computer main unit and a notebook computer wirelessly.

FIG. 14 is a schematic drawing illustrating a white balance device installed in a video projector in accordance with the present invention.

FIG. 15 is a schematic sectional side view of the embodiment shown in FIG. 14.

### DETAILED DESCRIPTION OF THE PREFERRED EMBODIMENT

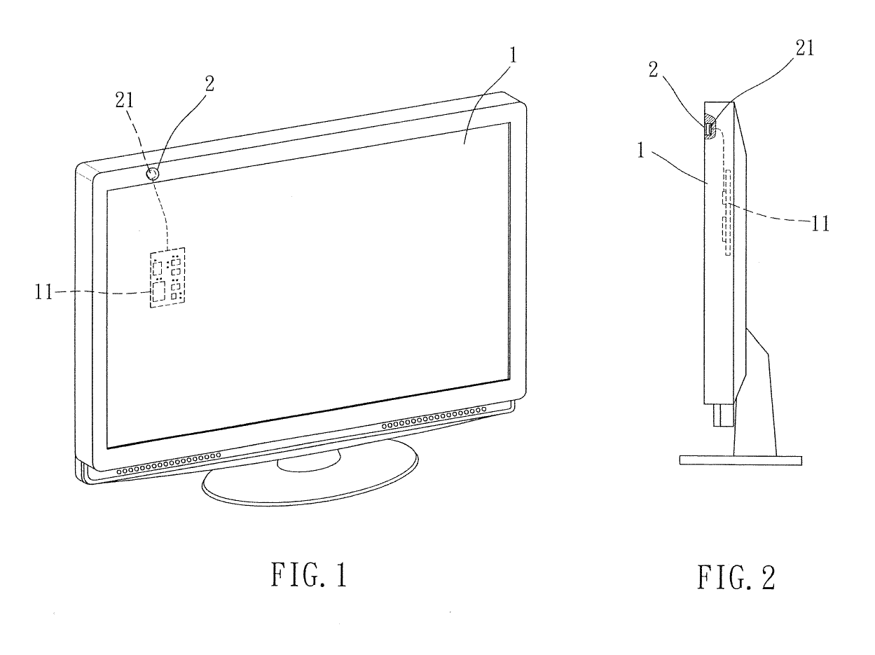

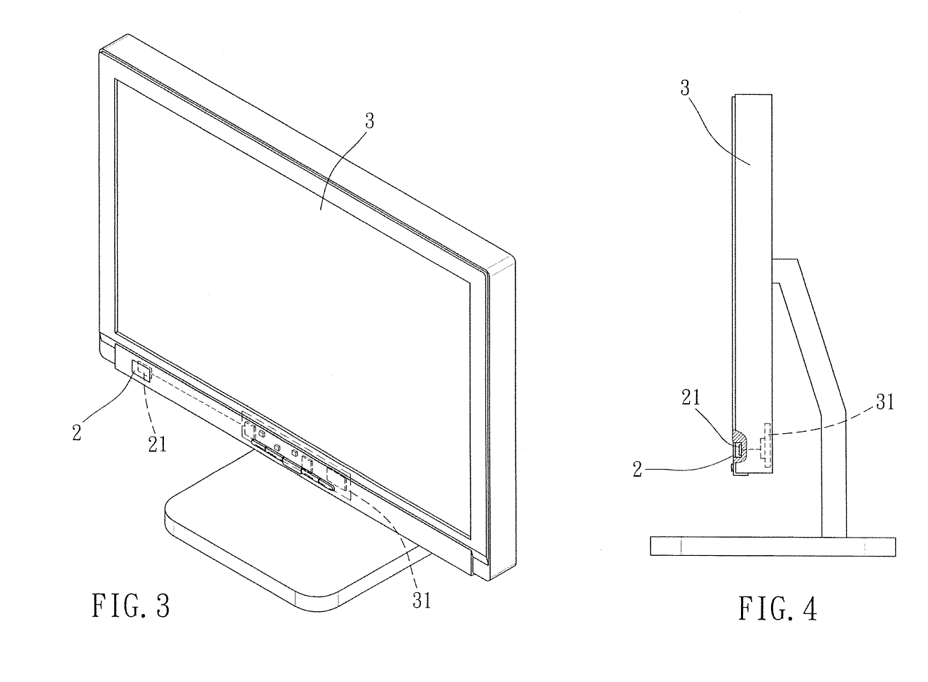

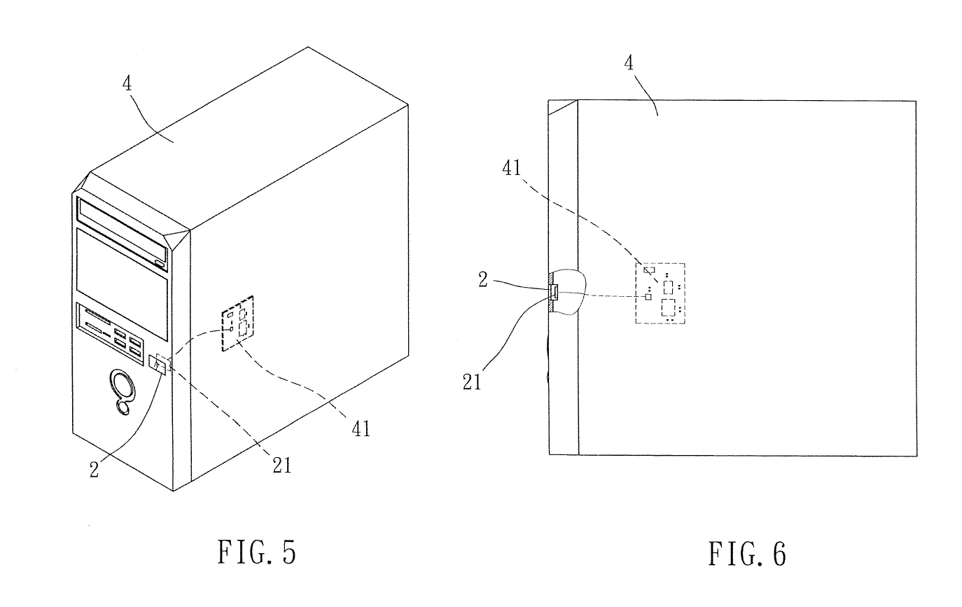

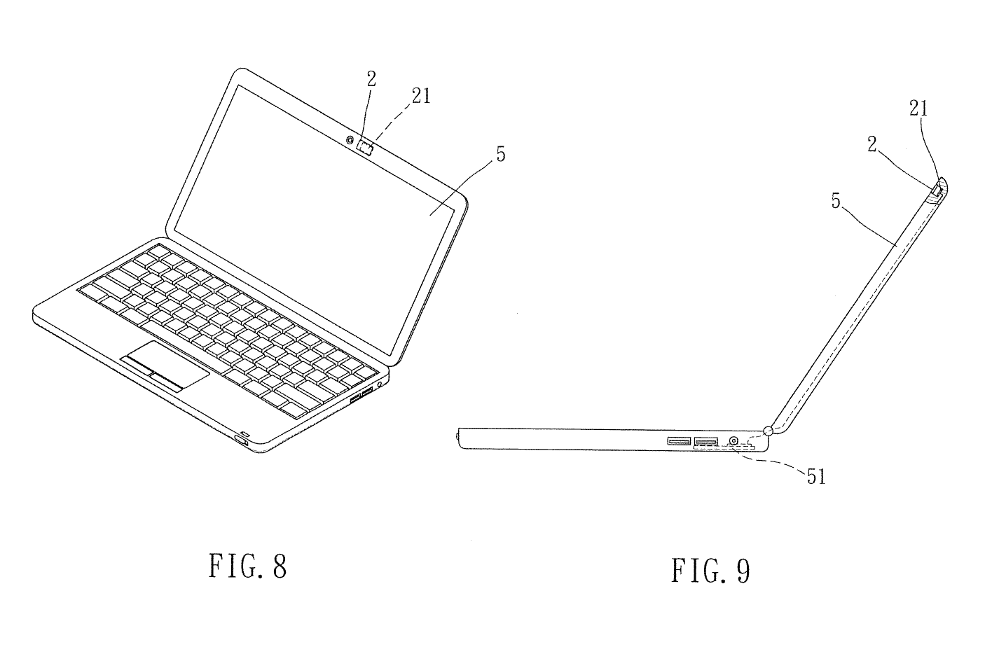

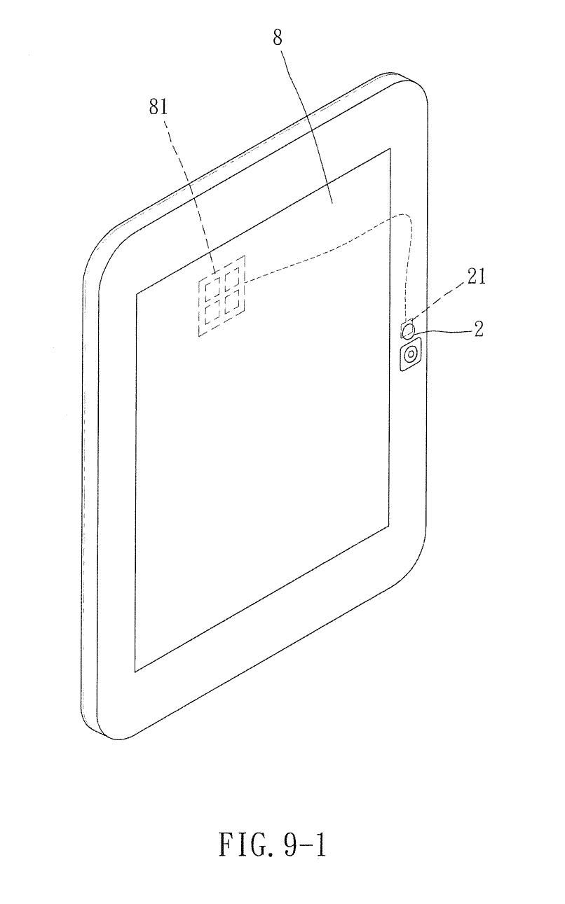

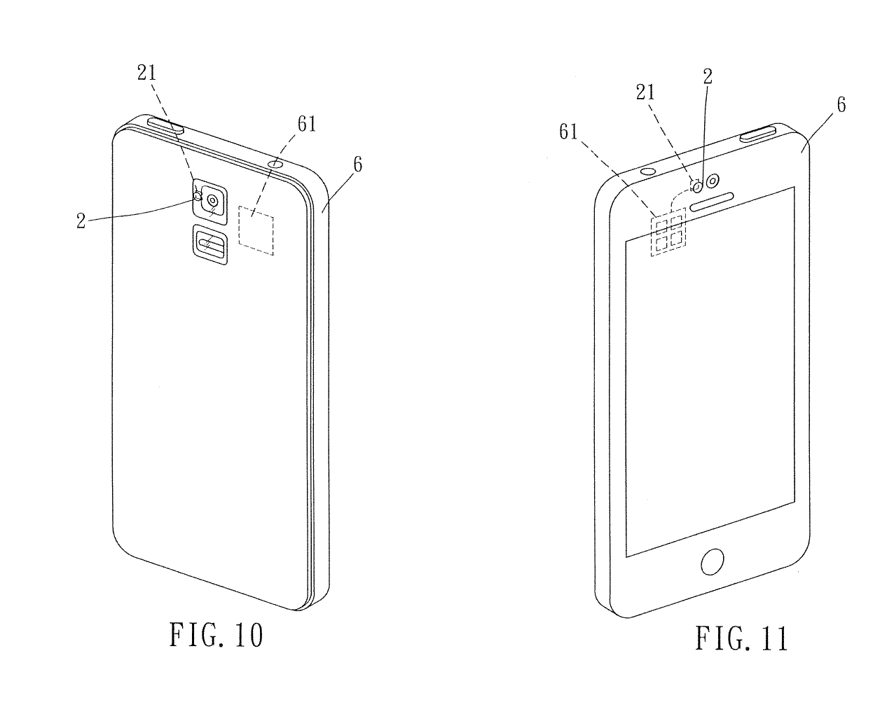

Referring to FIGS. 1-6 and FIGS. 8-11, a display white balance device in accordance with the present invention is shown used in a television (1), computer monitor (3), computer main unit (4), notebook computer (5), tablet computer (8), camera, video camera, video recorder, video monitor, network camera or mobile phone (6), comprising a white or gray light transmitting sheet (2) and a color temperature sensing element (21). When an external light passes through the white or gray light transmitting sheet (2), it is changed into uniform neutral light that falls upon the color temperature sensing element (21), causing the color temperature sensing element (21) to induce a spot color temperature signal and to provide the signal to a CPU (11)(31)(41)(51)(61)(81) of the television (1), computer monitor (3), computer main unit (4), notebook computer (5), tablet computer (8), camera, video camera, video recorder, video monitor, network camera or mobile phone (6), where the CPU (11)(31)(41)(51)(61)(81) runs a white balance calculation process on the retrieved color temperature value to obtain an accurate white balance (color temperature) value and to further automatically adjust the spot color temperature of the video screen subject to the accurate white balance (color temperature), enabling human eyes to see the displayed pictures or videos in the correct color.

Alternatively, the accurate white balance (color temperature) value obtained from the retrieved color temperature value through a white balance calculation process can be displayed on the window of the display screen of the television (1), computer monitor (3), computer main unit (4), notebook computer (5), tablet computer (8), camera, video camera, video recorder, video monitor, network camera or mobile phone (6), enabling the color temperature of the display device to be manually adjusted subject to the displayed white balance (color temperature) value. Thus, human eyes can see the displayed pictures or videos in the correct color.

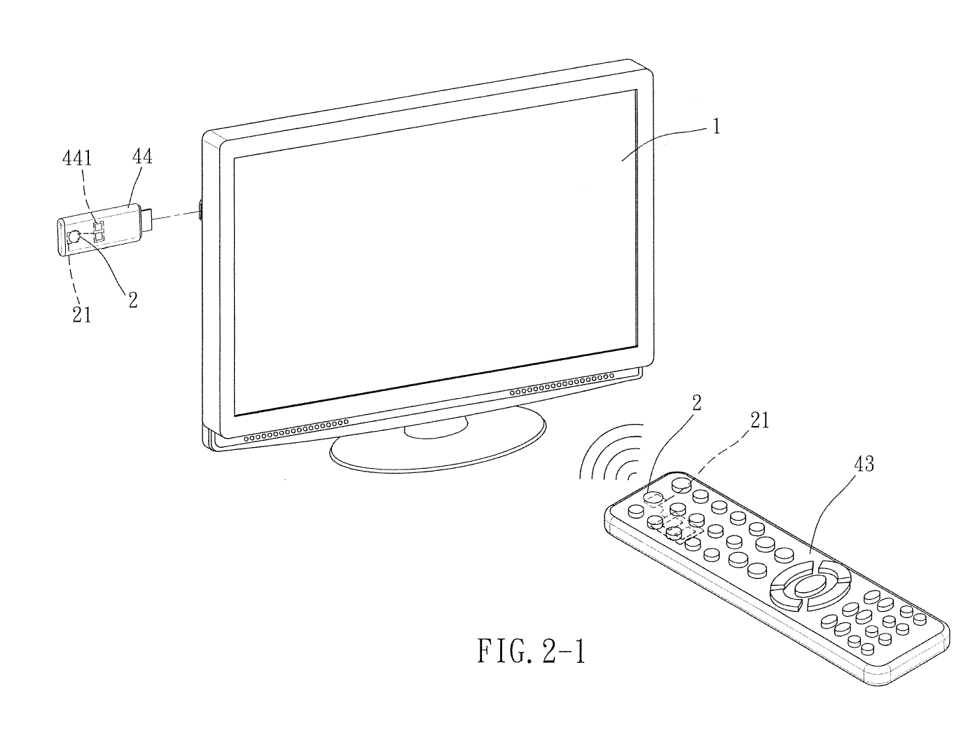

Further, the white or gray light transmitting sheet (2) and color temperature sensing element (21) of the white balance device of the present invention can be installed in a remote controller (43) of a television (1) or any other audio/video entertainment equipment, a mini network computer (44), or a TV stick. Thus, the white balance device can change incident light into uniform neutral light and induce a spot color temperature signal, and then transmit the accurate white balance value thus obtained to the CPU (11)(31)(41)(51)(61)(81)(441) of the television (1), computer monitor (3), computer main unit (4), notebook computer (5), tablet computer (8), mini network computer (44), camera, video camera, video recorder, video monitor, network camera or mobile phone (6) through a cable or a wireless transmission interface, enabling the CPU (11)(31)(41)(51)(61)(81) to run a white balance calculation processing on the retrieved color temperature value and to further obtain an accurate white balance (color temperature) value and automatically adjust the spot color temperature of the video screen, and thus, the color temperature of the video screen thereof can be automatically adjusted to become close to the natural color of the shooting scene (see FIG. 2-1).

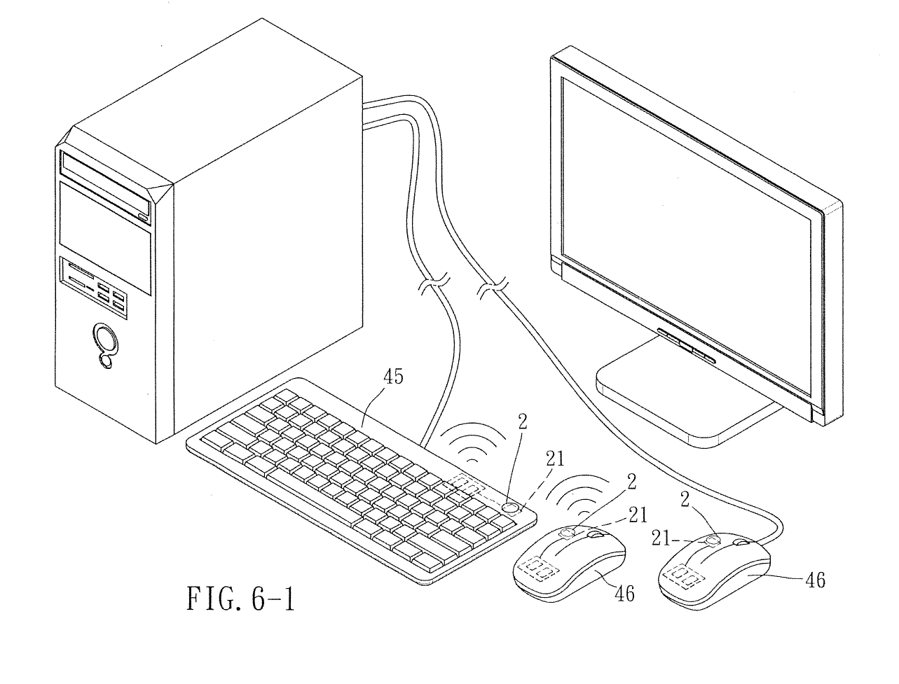

Further, the white or gray light transmitting sheet (2) and color temperature sensing element (21) of the white balance device of the present invention can be installed in a keyboard (45) or computer mouse (46). Thus, the white balance device can change incident light into uniform neutral light and induce a spot color temperature signal, and then transmit the accurate white balance value thus obtained to the computer main unit (4), television (1), computer monitor (3) or notebook computer (5), enabling the computer main unit (4), television (1), computer monitor (3) or notebook computer (5) to run a white balance calculation processing on the retrieved color temperature value and to further obtain an accurate white balance (color temperature) value, and thus, the spot color temperature of the video screen of the computer main unit (4), television (1), computer monitor (3) or notebook computer (5) can be automatically adjusted to become close to the natural color of the shooting scene (see FIG. 6-1).

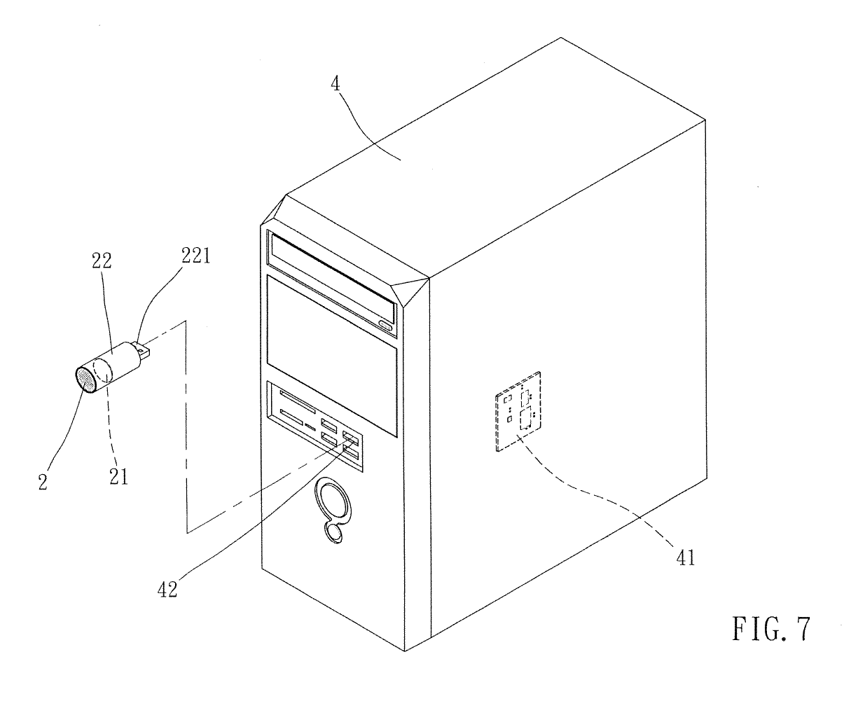

Referring to FIG. 7, a white balance device of the present invention can be made in a detachable form detachably connectable to a computer main unit (4). As illustrated, the detachable white balance device in accordance with this embodiment comprises a housing (22), a white or gray light transmitting sheet (2) mounted in a front side of the housing (22), a color temperature sensing element (21) mounted in the housing (22) and spaced behind the white or gray light transmitting sheet (2), and a male electrical connector (221) located at an opposing rear side of the housing (22) and electrically coupled with the color temperature sensing element (21) and detachably connectable to a mating female electrical connector (42) of the computer main unit (4) (or a television, computer monitor, notebook computer, tablet computer, camera, video camera, image projector or mobile phone). Thus, the white balance device can change incident light into uniform neutral light and induce a spot color temperature signal, and then transmit the accurate white balance value thus obtained to the CPU (41) of the computer main unit (4), enabling the CPU (41) to run a white balance calculation processing on the retrieved color temperature value and to further obtain an accurate white balance (color temperature) value, and then to automatically adjust the color temperature of the video screen.

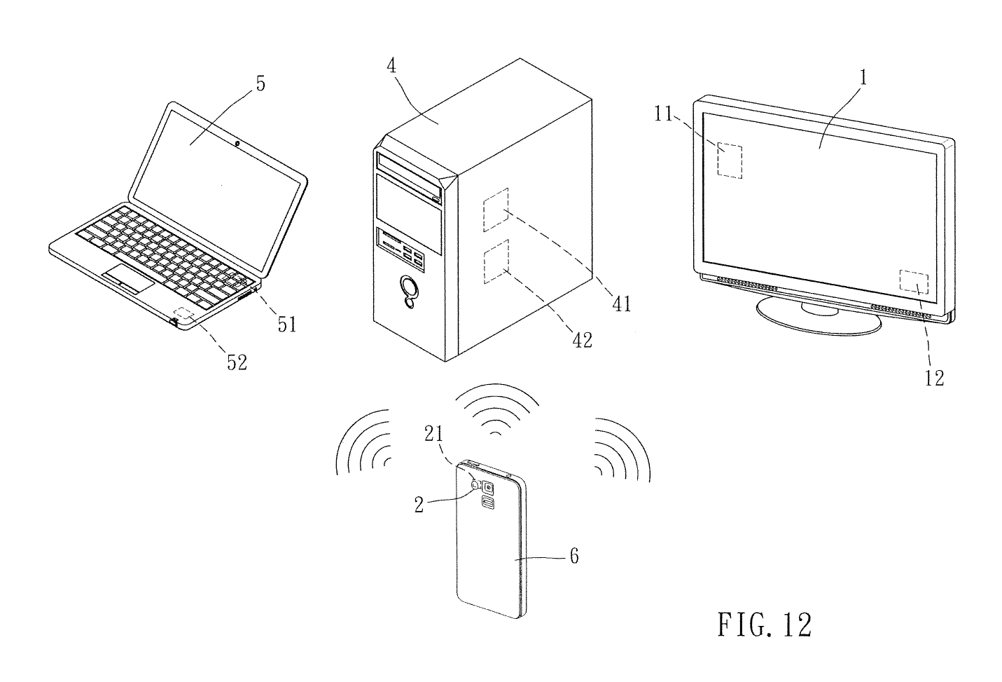

Referring to FIG. 12, a television (1), a computer main unit (4) and a notebook computer (5) are respectively equipped with a wireless receiver (12)(42)(52) for receiving a white balance value from a mobile phone (6). The mobile phone (6) has installed therein a white balance device comprised of a white or gray light transmitting sheet (2) and a color temperature sensing element (21). Subject to the functioning of the he white balance device white or gray light transmitting sheet (2) and the color temperature sensing element (21), the white balance device measures a color temperature value from the surroundings, and then the mobile phone (6) is controlled to transmit the color temperature value measured by the built-in white balance device to the wireless receiver (12)(42)(52) of the television (1), computer main unit (4) or notebook computer (5) wirelessly. The television (1), computer main unit (4) or notebook computer (5) uses a wireless network card or wireless connector to receive the color temperature value transmitted by the mobile phone (6), enabling the color temperature value to be further transmitted to a CPU (11)(41)(51) in the television (1), computer main unit (4) or notebook computer (5) for white balance calculation processing to obtain an accurate white balance (color temperature) value and automatically adjust the spot color temperature of the video screen so that the spot color temperature of the video screen of the television (1), computer main unit (4) or notebook computer (5) can be automatically adjusted. The television (1), computer main unit (4) or notebook computer (5) can be equipped with a wireless network card, or attached with a wireless connector for receiving wireless signals. Further, the wireless receiver (12)(42)(52) can also be installed in a computer monitor (3), tablet computer, camera or video camera for receiving white balance (color temperature) value from the mobile phone (6) in a wireless manner. Further, the built-in image pickup device of a video camera, mobile phone, video recorder, video monitor, network camera or tablet computer can be configured for white balance calculation processing to obtain the ambient color temperature value, enabling a built-in operating system or application software to set the working color temperature for its display device.

Alternatively, the internal CCD or CMOS image sensor of the video camera, smart phone, video camera, video recorder, monitor, network camera or tablet computer can be used to receive incident light and to induce a spot color temperature, and then to provide the spot color temperature to a CPU of the video camera, smart phone, video camera, video recorder, monitor, network camera or tablet computer for white balance calculation, enabling the calculated accurate white balance (color temperature) value to be transmitted wirelessly to the wireless receiver (12)(42)(52) of the television (1), tablet computer, mobile phone (6), computer main unit (4) or notebook computer (5), achieving automatic adjustment of the color temperature of its display device to meet the spot color temperature. Alternatively, the measured spot color temperature value can be displayed on the display screen of the television (1), mobile phone (6), tablet computer, notebook computer (5) or personal computer for manual adjustments.

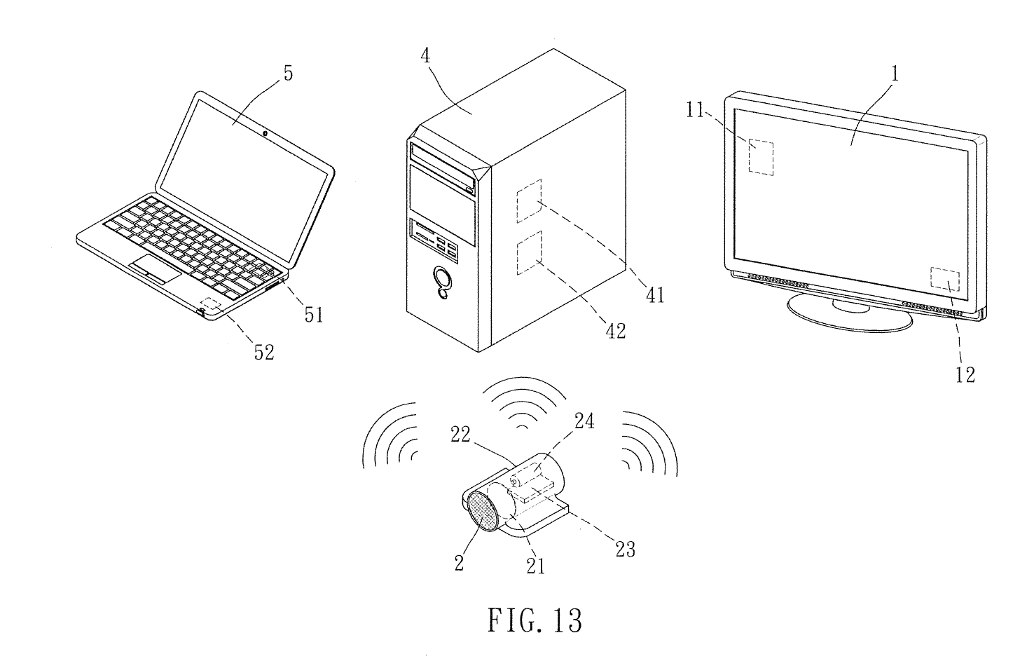

Referring to FIG. 13, an independent white balance device in accordance with the present invention can be made in an independent form and equipped with a wireless transceiver (23) and a battery (24), capable of transmitting the measured white balance (color temperature) value to a television (1), computer main unit (4) or notebook computer (5). According to this embodiment, the independent white balance device comprises a housing (22), a white or gray light transmitting sheet (2) mounted in a front side of the housing (22), a color temperature sensing element (21) mounted in the housing (22) and spaced behind the white or gray light transmitting sheet (2), and a wireless transceiver (23) and a battery (24) mounted in the housing (22) and electrically coupled with the color temperature sensing element (21). Through the white or gray light transmitting sheet (2) and the color temperature sensing element (21), the independent white balance device measures the color temperature of incident light, and then transmits the measured color temperature value wirelessly through the wireless transceiver (23) to the wireless receiver (12)(42)(52) of the television (1), computer main unit (4) or notebook computer (5), enabling the color temperature value to be further transmitted by the wireless receiver (12)(42)(52) to the internal CPU (11)(41)(51) of the television (1), computer main unit (4) or notebook computer (5) for calculation and automatically adjust the spot color temperature of the video screen, and thus the spot color temperature of the video screen of the television (1), computer main unit (4) or notebook computer (5) can be automatically adjusted to become close to the natural color of the shooting scene.

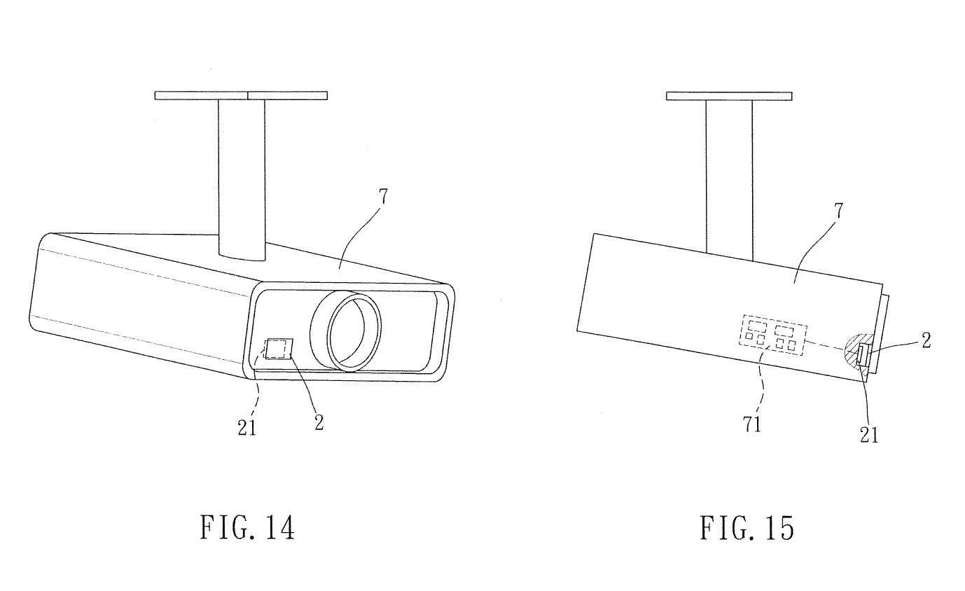

Referring to FIG. 14 and FIG. 15, a white balance device comprised of a white or gray light transmitting sheet (2) and a color temperature sensing element (21) in accordance with the present invention can be used in a video projector (7). When an external light passes through the white or gray light transmitting sheet (2), it is changed into uniform neutral light that falls upon the color temperature sensing element (21), causing the color temperature sensing element (21) to induce a spot color temperature signal and to provide the signal to a CPU (71) in the video projector (7) for white balance calculation and automatically adjust the spot color temperature of the video screen so as to obtain an accurate white balance (color temperature) value and to further automatically adjust the spot color temperature of the video screen, enabling human eyes to see the displayed pictures or videos in the correct color.

In conclusion, the invention provides a white balance device with wireless function for automatically obtaining an accurate white balance (color temperature) value and transmitting the obtained white balance (color temperature) value to an electronic apparatus having a display device, enabling the spot color temperature of the video screen to be automatically or manually adjusted.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A white balance device comprising a white or gray light transmitting sheet and a color temperature sensing element and installed in a television, computer monitor, computer main unit, notebook computer, tablet computer, camera, video camera, video recorder, video monitor, network camera, video projector or mobile phone, for enabling incident light to pass through said white or gray light transmitting sheet and then to be converted by said white or gray light transmitting sheet into a neutral light that falls upon said color temperature sensing element, causing said color temperature sensing element to induce a spot color temperature signal and to provide the signal to a CPU of said television, computer monitor, computer main unit, notebook computer, tablet computer, camera, video camera, video recorder, video monitor, network camera, video projector or mobile phone where said CPU runs a white balance calculation processing on the retrieved color temperature value to obtain an accurate white balance (color temperature) value and to further adjust the spot color temperature of the video screen of said television, computer monitor, computer main unit, notebook computer, tablet computer, camera, video camera, video recorder, video monitor, network camera, video projector or mobile phone subject to the obtained accurate white balance (color temperature) value.

2. The white balance device as claimed in claim 1, wherein said CPU displays the acute spot white balance value obtained through a white balance calculation process on the received spot color temperature value on the video screens of the television, computer main unit, notebook computer, tablet computer, camera, video camera, video projector and mobile phone, and then the spot color temperatures of the video screens are adjusted manually to comply with the spot color temperature, enabling human eyes to see the displayed pictures or videos in the correct color.

3. The white balance device as claimed in claim 1, wherein the white balance device is an independent form comprising a housing, a white or gray light transmitting sheet mounted in a front side of said housing, a color temperature sensing element mounted in said housing and spaced behind said white or gray light transmitting sheet housing, and a male electrical connector located at an outer side of said housing and electrically coupled with said color temperature sensing element and connectable to a female electrical connector of a television, computer monitor, computer main unit, notebook computer, tablet computer, camera, video camera, video projector or mobile phone, for enabling incident light to pass through said white or gray light transmitting sheet and then to be converted by said white or gray light transmitting sheet into a neutral light that falls upon said color temperature sensing element, causing said color temperature sensing element to induce a spot color temperature signal and to provide the signal to a CPU of said television, computer monitor, computer main unit, notebook computer, tablet computer, camera, video camera, video recorder, video monitor, network camera, video projector or mobile phone where said CPU runs a white balance calculation processing on the retrieved color temperature value to obtain an accurate white balance (color temperature) value and to further adjust the spot color temperature of the video screen of said television, computer monitor, computer main unit, notebook computer, tablet computer, camera, video camera, video recorder, video monitor, network camera, video projector or mobile phone subject to the obtained accurate white balance (color temperature) value.

4. The white balance device as claimed in claim 1, wherein said television, computer monitor, computer main unit, notebook computer, tablet computer, camera, video camera, video recorder, video monitor, network camera, video projector or mobile phone comprises a wireless for receiving a white balance value from a white balance device in a mobile phone and then transmitting the received white balance value to the CPU of the television, computer main unit or notebook computer for white balance calculation processing so as to obtain an accurate white balance (color temperature) value for automatically adjusting the spot color temperature of the television, computer monitor or notebook computer to be close to the ambient color temperature of its location.

5. The white balance device as claimed in claim 4, wherein said television, computer monitor, computer main unit, notebook computer, tablet computer, camera, video camera, video recorder, video monitor, network camera, video projector or mobile phone comprises a wireless network card or has a wireless connector connected thereto.

6. The white balance device as claimed in claim 4, wherein an internal CCD or CMOS image sensor of a smart phone is used to receive incident light and to induce a spot color temperature, and then to provide the spot color temperature to a CPU of the smart phone for white balance calculation processing, enabling the calculated accurate white balance (color temperature) value to be transmitted in a wireless manner to a wireless receiver of a television, computer main unit or tablet computer for automatic adjustment of the color temperature of the display device of the television, computer main unit or tablet computer to meet the spot color temperature.

7. The white balance device as claimed in claim 3, wherein the independent white balance device further comprises a wireless transceiver and a battery mounted in said housing and electrically coupled with said color temperature sensing element, capable of transmitting the measured white balance value in a wireless manner to the wireless receiver of the television, computer monitor, computer main unit, tablet computer, notebook computer, camera or video camera, enabling the white balance value to be further transmitted to the CPU of the television, computer monitor, computer main unit, tablet computer, notebook computer, camera or video camera for calculation and further automatic adjustments of the color temperature of the video screen to meet the spot color temperature.

8. The white balance device as claimed in claim 1, wherein the display device is capable of receiving an external white balance color temperature value through a cable or wireless interface, and then automatically adjusting the spot color temperature of the video device or displaying the received white balance color temperature value on display screen for further manual adjustments.

9. The white balance device as claimed in claim 1, wherein the white balance device is installable in a remote controller of a television or audio/video entertainment equipment, a mini network computer, or a TV stick, so that the white balance device is capable of changing incident light into uniform neutral light and then inducing a spot color temperature signal, and then transmitting the accurate white balance value thus obtained to the CPU of the television, computer monitor, computer main unit, notebook computer, mini network computer through a cable or a wireless transmission interface, enabling the CPU to run a white balance calculation processing on the retrieved color temperature value and to further obtain an accurate white balance (color temperature) value, and then to automatically adjust the spot color temperature of the display screen thereof.

10. The white balance device as claimed in claim 1, wherein the white balance device is mountable in a keyboard or computer mouse to measure the ambient color temperature and then to transmit the measured color temperature value through a cable or wireless interface to a CPU of a computer main unit, television, computer monitor or notebook computer for calculation and further automatic adjustment of the color temperature of the display screen to meet the spot color temperature.

11. The white balance device as claimed in claim 1, wherein a built-in image pickup device of a video camera, mobile phone, video recorder, video monitor, network camera or tablet computer is configured to process white balance calculation so as to obtain the ambient color temperature value, enabling a built-in operating system or application software to set the working color temperature of the display screen.
